(19) United States
(12) Patent Application Publication
(10) Pub. No.: US 2012/0112981 A1
(43) Pub. Date: May 10, 2012

(54) ANTENNA MOUNTING APPARATUS

(75) Inventors: Philip Crowther, Luton (GB); Mark Pawulski, Luton (GB)

(73) Assignee: Elster Metering Ltd., Luton (GB)

(21) Appl. No.: 13/252,900

(22) Filed: Oct. 4, 2011

(30) Foreign Application Priority Data
Oct. 4, 2010 (GB) 1016680.9

(51) Int. Cl. H01Q 1/42

(52) U.S. Cl. 343/872

(57) ABSTRACT

Various embodiments include an apparatus for mounting a water-meter antenna in a boundary box lid, including an inverted vessel adapted to both receive said antenna and orient said antenna such that in use the electro-magnetic radiation substantially propagates out of a boundary box covered by the boundary box lid, wherein either: i) the inverted vessel further comprises resilient mounting means adapted to secure the antenna in said vessel; or ii) a carrier is provided that is adapted to receive the vessel, the carrier preferably comprising resilient mounting means adapted to secure the inverted vessel in said carrier.

### CLAIM OF PRIORITY

This application claims the benefit of priority under 35 U.S.C. §119 of United Kingdom Patent Application Serial Number 1016680.9, entitled “ANTENNA MOUNTING APPARATUS,” filed on Oct. 4, 2010, the benefit of priority of which is claimed hereby, and which is incorporated by reference herein in its entirety.

The present invention relates to apparatus for mounting a water-meter antenna in a boundary box lid to prevent water from surrounding the antenna. The invention further relates to a combination of such a mounting apparatus and a boundary box lid.

### BACKGROUND

The present apparatus relates to the mounting of water-meter radio antenna in meter pit pads, which are in turn mounted in boundary box lids; meter pit pads are mounting devices that enable water-meter related apparatus to be mounted to boundary boxes. The antenna is required to enable transmission of data from the water-meter to external water-meter readers. Conventionally, boundary box lids are manufactured from metal, such as cast iron, and the antenna is mounted within the boundary box. Placing the antenna beneath the lid causes severe attenuation of the antenna signal requiring significant power input to the antenna to ensure that the water-meter may be read by the external reader. In addition, placing the antenna within the boundary box results in the possibility of the antenna being surrounded by water when the boundary box floods, thus increasing the attenuation of the signal emanating from the antenna. The present invention seeks to ameliorate these and other problems.

### STATEMENTS OF INVENTION

According to a first aspect of the present invention there is provided an apparatus for mounting a water-meter antenna in a boundary box lid, including an inverted vessel adapted to both receive said antenna and orient said antenna such that in use the electro-magnetic radiation substantially propagates out of a boundary box covered by the boundary box lid, wherein either: i) the inverted vessel further comprises resilient mounting means adapted to secure the antenna in said vessel; or ii) a carrier is provided that is adapted to receive the vessel, the carrier preferably comprising resilient mounting means adapted to secure the inverted vessel in said carrier. By providing such an inverted vessel the propagation of radio waves emanating from the boundary box may be more efficient; further, a modular arrangement may be provided with easily-serviceable or replaceable parts.

Preferably, the inverted vessel is adapted to receive an antenna adapted to propagate radio waves radially. By receiving such an antenna, the propagation of the radio waves from the boundary box may be further increased. More preferably, in use, the inverted vessel orients said antenna axis such that the axis is substantially parallel to the boundary box lid. By doing so, the radial nature of radio waves from such an antenna is utilised to yet further increase the efficiency of the propagation.

Preferably, in use, said inverted vessel is adapted to prevent water surrounding said antenna when the boundary box floods. By preventing water surrounding the antenna the propagation characteristics of the antenna may be improved. More preferably, in use said inverted vessel is adapted to form an air-pocket around said antenna when the boundary box floods. By creating an air-pocket water is prevented from surrounding the antenna.

Preferably, the inverted vessel is adapted to substantially prevent the transfer of loads from said vessel to the antenna. By preventing the transfer of loads the lifetime of the antenna may be extended. More preferably, the transfer of loads is substantially prevented by providing an air gap between the sealed end of the vessel and the antenna.

Preferably, the inverted vessel further comprises resilient mounting means adapted to secure the antenna in said vessel. More preferably, the resilient mounting means are flexible tabs. By providing such mounting means, the antenna may be simply mounted without the requirement for fasteners.

Preferably, the apparatus further comprises a carrier adapted to receive the vessel. The carrier may be adapted to receive the vessel in a u-shaped bracket, said u-shaped bracket incorporating resilient mounting means. More preferably, the vessel is an antenna housing. More preferably, the apparatus incorporates an antenna, the antenna is sealed within the housing. Yet more preferably, the antenna is potted (for example with a resin) within said housing. By sealing an antenna within the antenna housing water is prevented from accessing antenna during transportation to the site it is to be mounted in.

Preferably, the vessel includes a notch for receiving an antenna signal cable.

Preferably, the vessel is adapted to be mounted such that the sealed end of said vessel is substantially in the same plane as the external face of the boundary box lid.

Preferably, at least one surface of the carrier may be domed. More preferably, at least one surface of the carrier comprises at least one nodule adapted to conform to a portion of the vessel. The perimeter lip of at least one surface of the carrier may be more pronounced in the vicinity of a nodule compared to positions not in the vicinity of a nodule. These features may provide strength, while allowing the antenna to sit high in the structure to potentially increase the efficiency of the propagation.

Preferably, the vessel is manufactured from a polymer. By manufacturing the vessel from a polymer the attenuation of the radio waves emanating from the antenna may be reduced.

According to a further aspect of the present invention, there is provided a combination comprising an apparatus for mounting a water-meter antenna as aforementioned, and a boundary box lid, wherein the boundary box lid is adapted to receive said mounting apparatus.

Preferably, the side walls of the inverted vessel comprise a receiving hole in the boundary box lid, and the lid of the inverted vessel comprise an antenna carrier, wherein a seal is made between said carrier and said boundary box lid.

Preferably, the boundary box lid is further adapted to receive a plurality of said mounting apparatuses.

According to a further aspect of the invention, there is provided apparatus for mounting a water-meter antenna in a boundary box lid, including an inverted vessel adapted to both receive said antenna and orient said antenna such that in use the electro-magnetic radiation substantially propagates out of a boundary box covered by the boundary box lid.

The invention extends to methods and/or apparatus substantially as herein described with reference to the accompanying drawings.

Apparatus and method features may be interchanged as appropriate, and may be provided independently one of another. Any feature in one aspect of the invention may be applied to other aspects of the invention, in any appropriate combination. In particular, method aspects may be applied to apparatus aspects, and vice versa.

Embodiments of this invention will now be described, by way of example only, with reference to the accompanying drawings, of which:

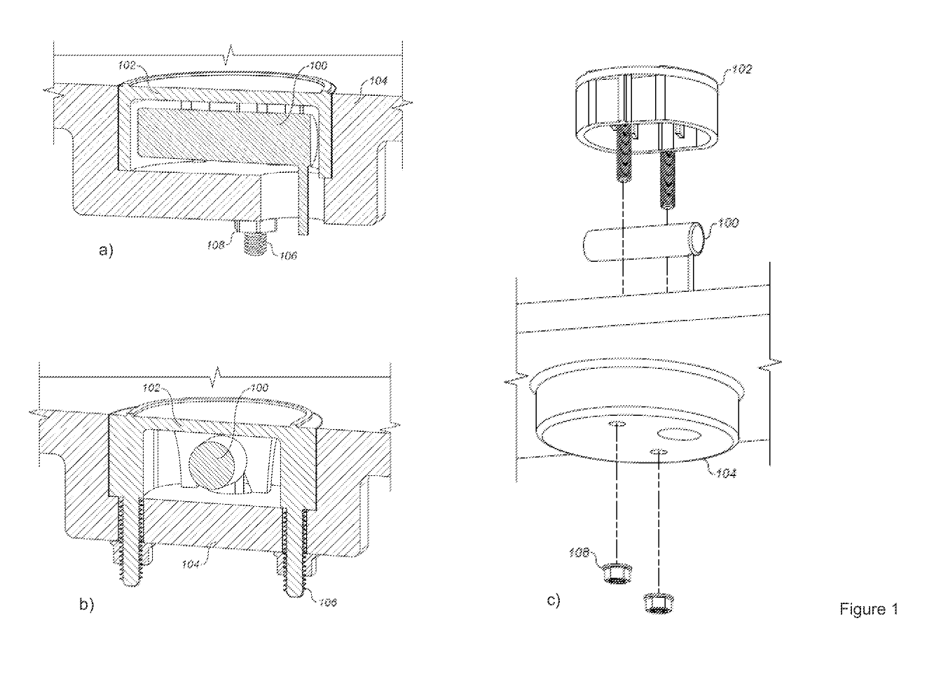

FIG. 1 show schematics of the antenna mounting apparatus;

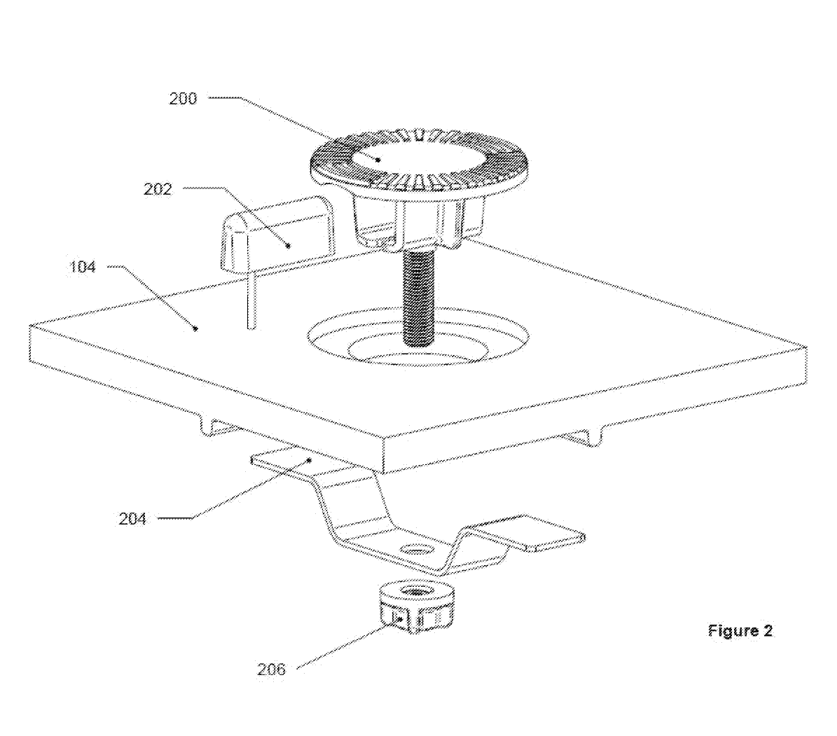

FIG. 2 shows a schematic of an alternative antenna mounting apparatus;

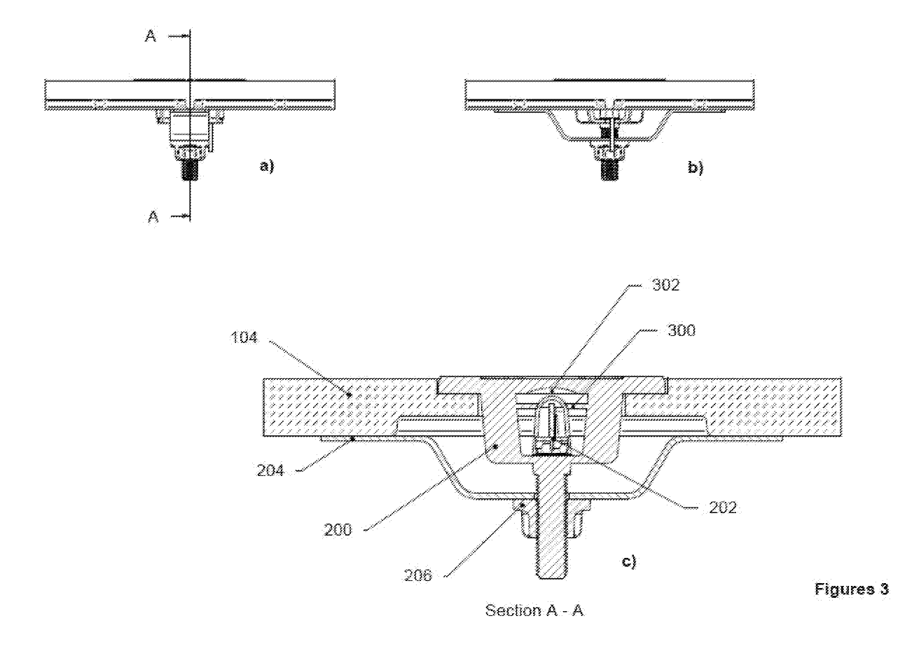

FIG. 3 show alternative views of the antenna mounting apparatus shown in FIG. 2;

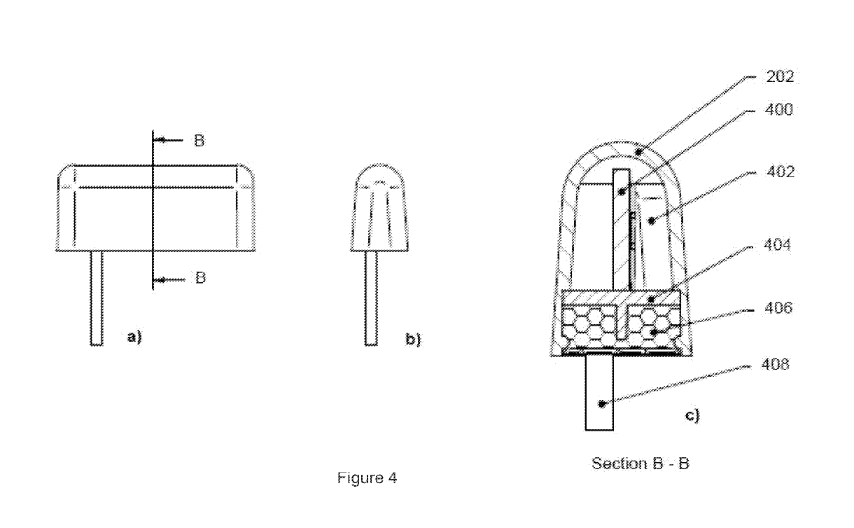

FIG. 4 shows a schematic of the antenna arrangement;

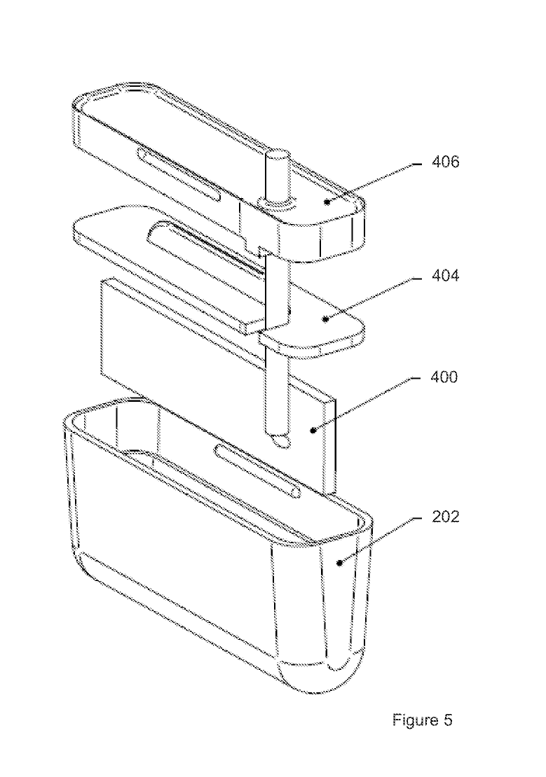

FIG. 5 shows an exploded view of the antenna arrangement shown in FIG. 4;

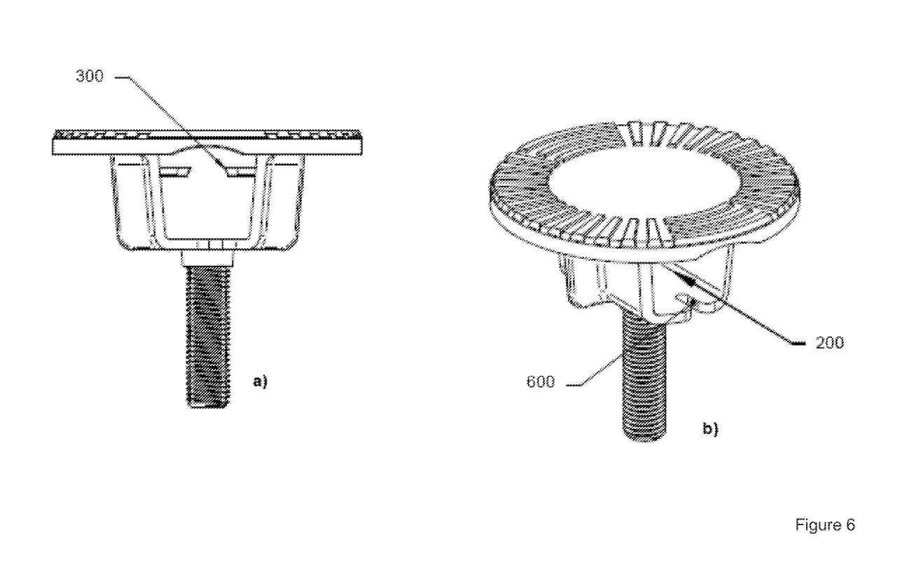

FIG. 6 show detailed schematics of the antenna mounting apparatus shown in FIG. 2;

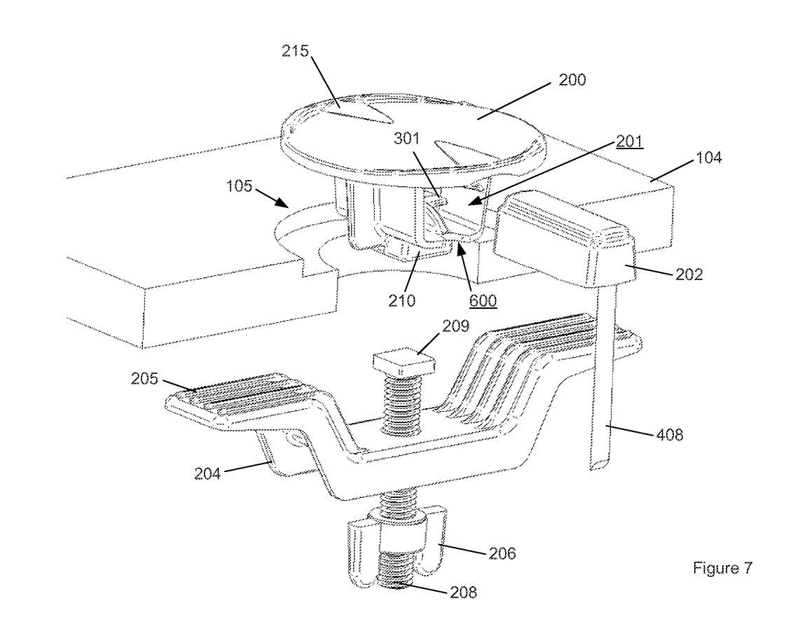

FIG. 7 shows an exploded view of further embodiment of the antenna mounting apparatus;

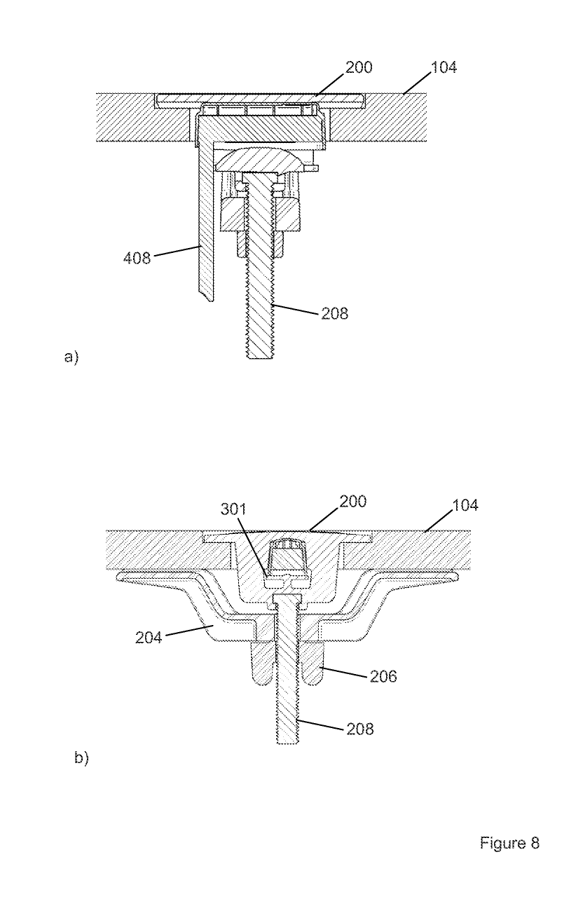

FIG. 8 show cross-sections of the example of FIG. 7 showing the antenna mounting apparatus in place in a pit lid;

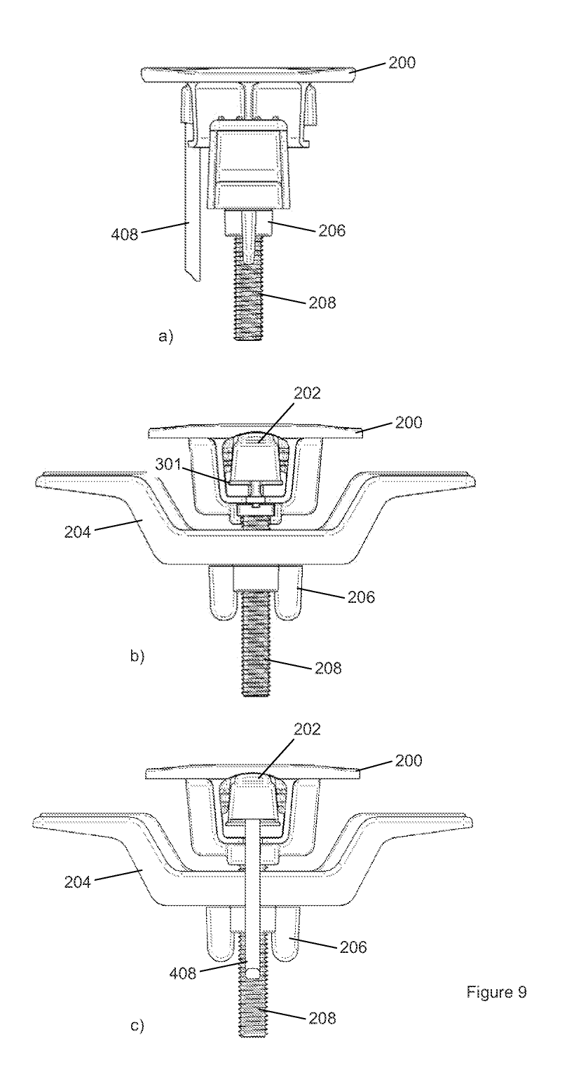

FIG. 9 show further cross-sections of the antenna mounting apparatus;

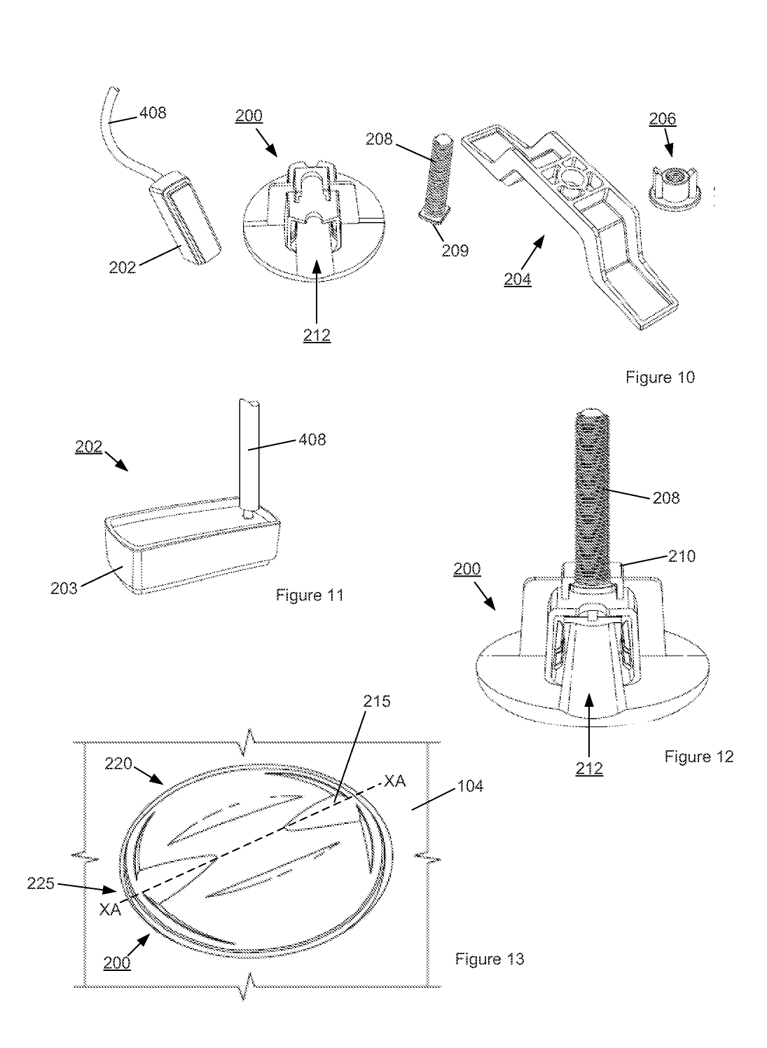

FIG. 10 show various components of the antenna mounting apparatus;

FIG. 11 shows the antenna housing;

FIG. 12 shows an underside view of the antenna mounting apparatus;

FIG. 13 shows a topside view of the antenna mounting apparatus; and

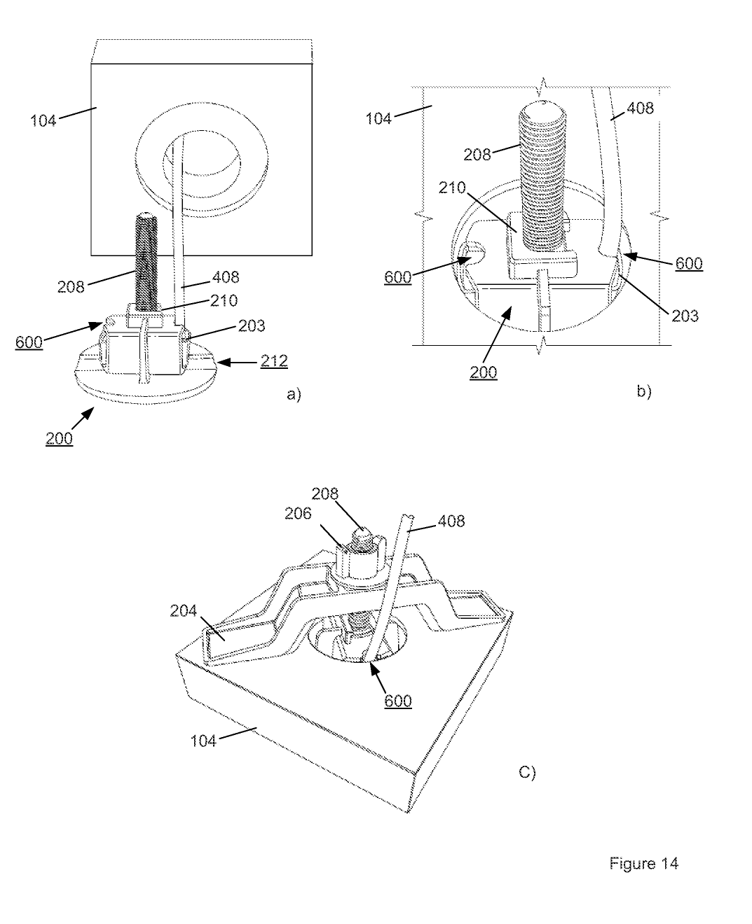

FIG. 14 show the installation of the antenna mounting apparatus into a pit lid (boundary box lid).

Referring to FIG. 1, the antenna 100 is mounted within the main carrier 102, which is in turn mounted within the pit lid (boundary box lid) 104. The threaded bolts 106 incorporated into the main carrier 102 are utilised in conjunction with nuts 108 to secure the main carrier within the pit lid 104. The antenna may be press fit within the main carrier 102, or alternatively may be held using a suitable bracket and fasteners. The antenna is oriented such that the propagation of the radio waves out of the boundary box is maximised; in this example, since the radio waves emanate from the antenna annularly the antenna is positioned horizontally. The antenna is manufactured on a PCB, not shown, and is essentially flat. However, the length of the antenna is likely to be greater than the length of the PCB to ensure the antenna matches the frequency of the radio signal. To achieve this feature, a number of types of antenna are available: a straight wire antenna (if the length required is relatively small); a wire dipole antenna; a flat zig-zagged antenna, produced by stamping a flat sheet of metal; and a flat helical antenna, produced by having angled strips on either side of the PCB coupled together using through board connections.

To prevent water from fully surrounding the antenna when the boundary box floods with water, the main carrier 102 is adapted to act as an upside-down cup. Thus, when the box floods with water, from below the main carrier and antenna assembly, an air-pocket is created which prevents water from surrounding the antenna. In addition, this arrangement allows the water to flow away from the main carrier when the flood water subsides. By mounting the antenna in such a way the requirement to fully seal the antenna in an air-pocket is reduced (a potentially costly requirement). Furthermore, fully sealing the antenna in an air-pocket can lead to the unexpected result of the antenna being surrounded by water, for example where the top of the main carrier is accidentally cracked the air-pocket would fill with water and could never flow away from the antenna. With the present apparatus, in this situation the water would simply flow away from the antenna immediately. Furthermore, the material utilised is minimised in order to reduce manufacturing costs. The antenna housing is manufactured from a polymer.

An alternative example of an antenna mounting apparatus is shown (in exploded view) in FIG. 2. The alternative main carrier 200 is adapted to receive and hold the antenna housing 202. The main carrier is located in the pit lid (boundary box lid) 104. The retaining means, bracket 204, in conjunction with nut 206, is utilised to secure the main carrier within the pit lid. Again, in this example the antenna is oriented such that the propagation of the radio waves from the antenna away from the pit lid is maximised.

The antenna mounting apparatus shown in FIG. 2 is shown in further detail in FIG. 3. FIGS. 3a and 3b show side views of the apparatus, with the antenna main carrier located in-situ within the pit lid. FIG. 3c shows cross-section A-A from FIG. 3a, in which the main carrier 200 is shown in-situ in the pit lid 104. Again, the main carrier is secured to the pit lid using the bracket 204 and nut 206. The main carrier is provided with a flange that engages and seals with the pit lid to locate the carrier in the correct axial position. In this example, the inverted vessel may be produced by the seal between the boundary box lid and the main carrier; thus water, when flooding the box from below, will be prevented from surrounding the antenna by the air-pocket generated in the cut-out of the boundary box lid that receives the carrier. The antenna housing 202 is shown within the main carrier, and is held in place using the flexible tabs 300. The tabs elastically deform when the antenna housing is inserted within the main carrier, and provide sufficient force on the antenna housing to secure it in position. An air-gap 302 is provided above the antenna housing to prevent the main carrier from damaging the antenna when it is under load; i.e. the main carrier can deform (e.g. when a car or the like passes over the pit lid) without transferring that deformation to the antenna.

FIG. 4 shows the antenna housing 202, and antenna PCB 400, in further detail. In this example, a sealed air gap 402 is provided around the antenna PCB; the PCB is held within the antenna housing by the cover 404. The antenna is potted to prevent water ingress into the housing during transport to the site the antenna is to be mounted in. The antenna is sealed within the antenna housing by the potting resin 406. The signal cable 408 passes through the potting resin and leads to the water-meter. The meter reading is therefore transmitted from the water-meter to the external reader via the antenna.

FIG. 5 shows an exploded view of the antenna housing 202 as shown in FIGS. 2, 3 and 4. As can be seen, the signal cable 408 passes from the PCB through a notch in the cover 404 and these passes through the potting resin 406. In an alternative, the PCB may be mounted perpendicular to the mounting position shown in FIG. 5; this may further increase the propagation of the radio waves out of the boundary box.

FIG. 6 shows a detailed view of the main carrier 200. The flexible tabs 300 can be seen in further detail, and as can be seen they are provided with tapered edges that cooperate with the antenna housing to secure it in position. Furthermore, as can be seen, the notch 600 is provided to enable the antenna and housing to be positioned within the main carrier without the signal cable fouling the carrier.

Alternatively, the inverted cup, or vessel, adapted to receive the antenna may comprise two parts: a first part being a hollow cylinder with mounting lugs to receive the antenna; and a second part being a lid to be permanently, or otherwise, fixed to one end of the cylinder to form the inverted vessel.

FIG. 7 shows an exploded view of a further embodiment of an antenna mounting apparatus. Main carrier 200 is shown for illustrative purposes in a position above the receiving hole or aperture 105 (which has a stepped profile, with the larger diameter at the upper surface of pit lid 104) of pit lid 104 into which it will be mounted, with antenna housing 202 aligned with but not inserted in antenna housing receiving chamber 201 of main carrier 200. Also shown are flexible, resilient tabs 301 to hold the antenna housing 202 in place.

In this example, threaded bolt 208 is entirely separate from the main carrier 200, and engages with it by means of a head 209 of the proximal end of bolt 208 being inserted into bolt mounting notch 210 located at the base of the main carrier 200.

Bracket 204, in this example, comprises longitudinal strengthening ribs 25 which also provide additional purchase on the underside of pit lid 104 to hold the antenna mounting apparatus in place.

FIG. 8 show cross-sections of an example of the antenna mounting apparatus of the example of FIG. 7 in place in a pit lid. Wing nut 206 is shown advanced into position, forcing arms of bracket 204 against the underside of the pit lid 104, securing the main carrier 200 against the upper side of the pit lid 104 and thereby holding the antenna assembly in place high within the main carrier 200. Antenna housing 202 is supported in place by flexible resilient tabs 301.

FIG. 9 show further cross-sections of the antenna mounting apparatus, showing the antenna arrangement in greater detail. Antenna housing 202 is supported in place by flexible resilient tabs 301.

FIG. 10 show various components of the antenna mounting apparatus.

FIG. 11 shows the antenna housing, showing the potting of the antenna and the arrangement of the signal cable 408 at one end of antenna housing 202 to allow it to be slid into antenna housing receiving chamber 201 of main carrier 200, the signal cable 408 slotting into notch 600. The ends 203 of the antenna housing 202 are curved to conform to the curvature of the inner circumference of the receiving hole or aperture 105 of pit lid 104, so that the antenna housing 202 is kept in place when the antenna mounting apparatus is inserted in the aperture 105.

FIG. 12 shows an underside view of the antenna mounting apparatus. Antenna housing receiving chamber 201 of main carrier 200 comprises a groove or channel 212 extending across the underside diameter of the main carrier 200 and shaped to accommodate the upper surface of antenna housing 202, thereby facilitating its insertion.

FIG. 13 shows a topside view of the antenna mounting apparatus. The profile of the top surface of main carrier 200 is slightly domed, with nodules 215 located on axis XA-XA orientated parallel to the antenna housing receiving chamber 201 to allow the antenna to sit as high within its structure (and therefore as near to the surface) as possible, while maintaining strength for a given amount of material. For additional strength, the perimeter lip of the top surface of main carrier 200 is pronounced at positions 225 in the vicinity of the nodules 215 compared to the orthogonal positions 220.

FIG. 14 show the installation of the antenna mounting apparatus into a pit lid (boundary box lid), in particular showing the interaction of threaded bolt 208 with bolt mounting notch 210, the threading of signal cable 408 through aperture 105 of pit lid 104 and slotting into notch 600 of antenna housing receiving chamber 201 of main carrier 200 as antenna housing 202 is slid into channel 212. Also shown is the antenna mounting apparatus held in place by the bracket 204, screw 208 and wing nut 206 arrangement.

There are many types of boundary boxes (pits), and many types of boundary box lids (i.e. pit lids). For example, the pit lid may be a hinged cast iron lid, or an iron lid. Furthermore, any such pit lid may house multiple antennas in multiple antenna carriers.

It is of course to be understood that the invention is not intended to be restricted to the details of the above embodiments which are described by way of example only, and modifications of detail can be made within the scope of the invention.

Each feature disclosed in the description, and (where appropriate) the claims and drawings may be provided independently or in any appropriate combination.

What is claimed is:

1. An apparatus for mounting a water-meter antenna in a boundary box lid, including an inverted vessel adapted to both receive said antenna and orient said antenna such that in use the electro-magnetic radiation substantially propagates out of a boundary box covered by the boundary box lid, wherein either:
i) the inverted vessel further comprises resilient mounting means adapted to secure the antenna in said vessel; or
ii) a carrier is provided that is adapted to receive the vessel, the carrier preferably comprising resilient mounting means adapted to secure the inverted vessel in said carrier.

2. The apparatus according to claim 1, wherein said inverted vessel is adapted to receive an antenna adapted to propagate radio waves radially.

3. The apparatus according to claim 2, wherein in use said inverted vessel orients said antenna axis such that the axis is substantially parallel to the boundary box lid.

4. The apparatus according to claim 1, wherein in use said inverted vessel is adapted to prevent water surrounding said antenna when the boundary box floods.

5. The apparatus according to claim 4, wherein in use said inverted vessel is adapted to form an air-pocket around said antenna when the boundary box floods.

6. The apparatus according to claim 1, wherein said inverted vessel is adapted to substantially prevent the transfer of loads from said vessel to the antenna.

7. The apparatus according to claim 6, said resilient mounting means being flexible tabs.

8. The apparatus according to claim 1, the carrier being adapted to receive the vessel in a u-shaped bracket, said u-shaped bracket incorporating resilient mounting means.

9. The apparatus according to claim 1, wherein the vessel is an antenna housing.

10. The apparatus according to claim 9, incorporating an antenna, the antenna being sealed within said housing.

11. The apparatus according to claim 10, said antenna being potted within said housing.

12. The apparatus according to claim 1, wherein said vessel includes a notch for receiving an antenna signal cable.

13. The apparatus according to claim 1, wherein said vessel is adapted to be mounted such that the sealed end of said vessel is substantially in the same plane as the external face of the boundary box lid.

14. The apparatus according to claim 1, wherein at least one surface of the carrier is domed.

15. The apparatus according to claim 1, wherein at least one surface of the carrier comprises at least one nodule adapted to conform to a portion of the vessel.

16. The apparatus according to claim 15, wherein the perimeter lip of at least one surface of the carrier is more pronounced in the vicinity of a nodule compared to positions not in the vicinity of a nodule.

17. The apparatus according to claim 1, said vessel being manufactured from a polymer.

18. A combination comprising an apparatus for mounting a water-meter antenna according to claim 1, and a boundary box lid, wherein the boundary box lid is adapted to receive said mounting apparatus.

19. A combination according to claim 18, the side walls of the inverted vessel comprising a receiving hole in the boundary box lid, and the lid of the inverted vessel comprising an antenna carrier, wherein a seal is made between said carrier and said boundary box lid.

20. A combination according to claim 18, wherein said boundary box lid is further adapted to receive a plurality of said mounting apparatuses.

21. An apparatus for mounting a water-meter antenna substantially as described herein with reference to any of the accompanying Figures.

22. A combination of a water-meter mounting apparatus and a boundary box lid substantially as herein described with reference to any of the accompanying Figures.
